(19) United States
(12) Patent Application Publication
(10) Pub. No.: US 2013/0316315 A1
(43) Pub. Date: Nov. 28, 2013

(54) Method And System For Improving Testing Assessment

(71) Applicant: Jae Song, Paramus, NJ (US)

(72) Inventor: Jae Song, Paramus, NJ (US)

(21) Appl. No.: 13/480,411

(22) Filed: May 24, 2012

(51) Int. Cl. G09B 19/00

(52) U.S. Cl. 434/238

(57) ABSTRACT

The method and system are based on knowledge branch structure which is a hierarchical categorization of a subject's fundamental and complex elements and PAQ which is designed to re-test students on only those concepts which give an ambiguous outcome. Therefore, the method and system act as a formative and summative assessment in one which provides teachers and students with accurate and in-depth analysis of data as well as descriptive feedback from the test data. Many embodiments of the invention can be implemented as an assessment tool on a computing system, more specifically through program/software.

### BACKGROUND OF THE INVENTION

1. Field of the Invention

The present invention relates to a method of and system for improving testing assessment, and more particularly to a method of and system for improving testing assessment on a basis of both formative and summative assessment.

2. Description of Related Art

Assessment Testing includes both a standardized testing assessment (summative assessment) and an adaptive testing (formative assessment, i.e. NWEA: MAP®).

A standardized test is a test in which the same questions are given in the same manner to all test takers. An adaptive testing involves selecting test items according to the examinee's ability as shown by responses to earlier test items so as to maximize the precision of the exam.

The strength of a standardized testing assessment (summative assessment, i.e. NJASK, SAT, state-administered exams) is that it is constructed to assess a specific ability, providing comparison among students. However, the main weakness is that it does not improve student's achievement. Other weaknesses include instruction time is consumed by monotonous test preparation; Excessive testing teaches children to be good at taking tests, but does not prepare them for productive adult lives; Standardized tests are an imprecise measure of teacher performance. It lacks in rigorous analysis of test results (uncertain of fundamental gaps).

The strength of an adaptive testing assessment (formative assessment, i.e. NWEA: MAP®) is that it is a unique test that is tailored to the individual student's ability level, providing assessment of individual strength. The main weakness, on the other hand, is that it does not improve classroom instruction. Other weaknesses include: it is not applicable for all subjects and skills, especially those in which the item response theory cannot be readily applied; it requires careful item calibration. This, in turn, requires that extensive data be collected on a large item pool. (The development of a sufficiently large item pool is one of the biggest constraints to the widespread use of CAT.)

Therefore, there is a need for a method and system that will assist teachers and students in better understanding the student's learning gaps, improve testing assessments so as to improve students' achievement.

### SUMMARY OF THE INVENTION

One object of the present invention is to provide teachers and students with accurate, in-depth analysis of test data.

Another object of the present invention is to provide teachers and students with descriptive feedback from test data.

A further object of the present invention is to provide teachers and students an assessment that combines and acts as a formative and summative assessment in one.

Many embodiments of the invention may be implemented on a computing system.

The method of and system for improving testing assessments and student's achievement according to the present invention comprises Knowledge Branch which is a hierarchical categorization of a subject's fundamental and complex elements (a type of knowledge map). It provides a color-coded graphic representation of test results based on correct and incorrect answers.

The method of and system for improving testing assessments and student's achievement further comprises PAQ which is designed to re-test students on only those concepts which give an ambiguous outcome. A smaller set of questions is given, after the initial test is taken, which provides more data to further analyze the ambiguous concepts. When test questions include multiple concepts, the quiz re-tests students by giving a certain number of questions on each of the basic concepts within the original question. In this way, the PAQ tests concepts to one extreme or the other: mastery or lack of comprehension. The PAQ also records time taken to answer each question in order to analyze mastery or lack of comprehension of problem solving/thinking technique.

Each question is timed to measure a student's efficiency in problem-solving. All outliers are eliminated and data is normalized to measure efficiency of only correct answers. This data is then used in student-to-student and student-to-overall average comparisons.

In the process of test data analysis, Knowledge Branch and PAQ together provide more clear, accurate and in-depth analysis of data such that teachers make effective use of data-driven instruction in order to increase students' achievement.

Furthermore, multiple knowledge branches can be derived from a question depending upon the taxonomy of elements determined by different school systems, district/federal standards, country standards, internal codes, etc. For a given question, it can have multiple sets of elements corresponding to a particular taxonomy: school, country, other system, etc. In other words, different schools and even different schools in various countries can have different sets of elements for the same question.

In this way, teachers and school administrators can not only visualize taxonomies but also compare the varying taxonomies that a single test can generate. They can analyze student performance from these knowledge branches and even investigate the “best” taxonomy based upon the analysis.

The best taxonomy can be identified from the knowledge branch which shows not only students' understanding of concepts but also the order by which they are understood to answer a multiple-element question. For instance, an algebra question can include the following elements: the number line, comparing numbers, order of operation, and special relationships. The order in which these elements are taught in the classroom (essentially a school's curriculum) differs among districts, states and countries.

With the knowledge branch tool, teachers and administrators can observe which taxonomy or put another way, curriculum, allows the student to learn the material more efficiently and accurately. Given the declining performance of students in the U.S., data-driven curricula building and instruction are necessary for schools to increase student performance and prepare them for college coursework.

With the results of assessment and standardized tests, teachers analyze which concepts a student has or has not yet mastered as a way to inform future lesson plans. Teachers and schools know that concepts build upon concepts so that curricular development, across all subjects and grade levels, is progressive. Foundational elements are taught before advanced and complex elements and both foundational and complex elements of a subject are tested. In higher grade levels, it becomes extremely difficult to distinguish between the two.

The knowledge branch tool, however, allows a teacher and student to visualize the distinctions and actually see where the lack of comprehension is occurring. With the tool, a teacher's curriculum or instructional plan is categorized and broken down into foundational and complex elements. Then, teachers can observe the elements that students consistently answer correctly or incorrectly. Not only that, teachers can observe the order in which the elements are taught and how this affects student performance. With the data, teachers can change or supplement the curriculum to address the needs of students and possibly analyze a more efficient taxonomy for student learning and mastering. With student data generating multiple knowledge branches, the more efficient taxonomy becomes more easily identifiable.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 illustrates a knowledge branch process;

FIG. 2 shows a knowledge branch structure;

FIG. 3 is a structure of test questions;

FIG. 4 illustrates that different schools can have different sets of elements for the same question;

FIG. 5 is an element assignment flow;

FIG. 6 illustrates a recursive knowledge branch;

FIG. 7 is a knowledge branch functions;

FIG. 8 is a flowchart showing a PAQ initiation and process loop according to an embodiment of the invention

FIG. 9 shows a normalization graph; and

FIG. 10 shows an efficiency analysis graph.

### DESCRIPTION OF THE PREFERRED EMBODIMENT

Many embodiments of the invention can be implemented as an assessment tool on a computing system, more specifically through programs/software.

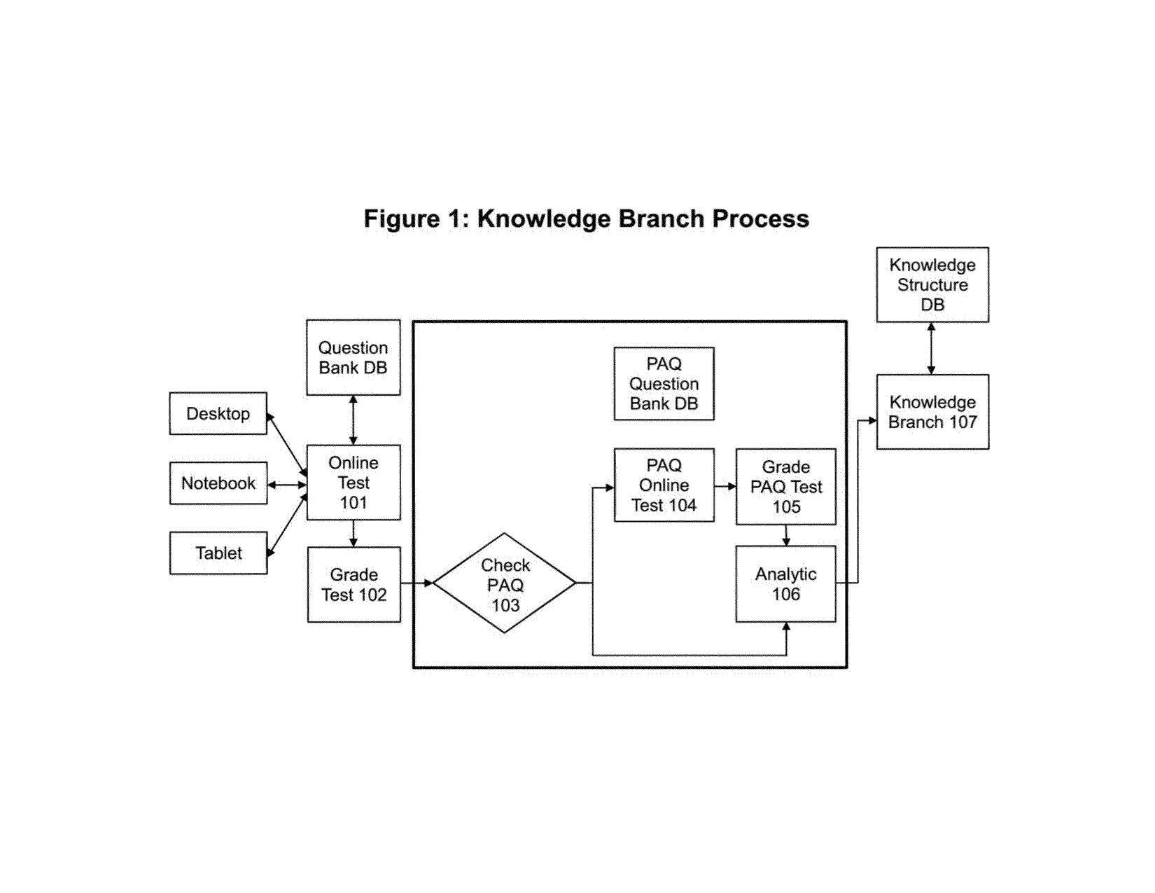

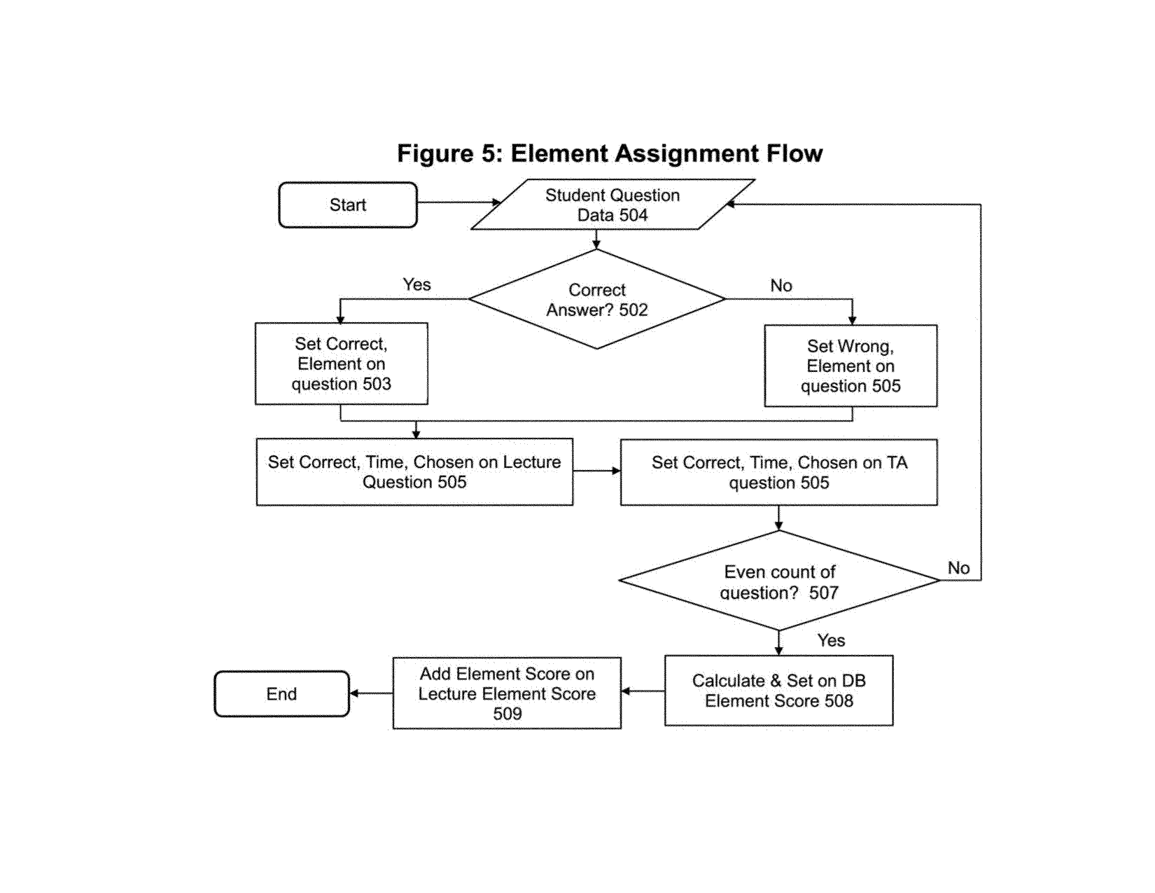

Referring to FIG. 1, there is disclosed a knowledge branch process which commences at step 101 where a student takes an online test of which the questions come from a question bank DB using any access including a desktop, notebook, or tablet. After the test is graded at 102, the system will determine whether a PAQ online test is necessary at 103. PAQ is incorporated into the knowledge branch process to enhance the accuracy and depth of the test data analysis. If a PAQ online test is necessary, the student will be given PAQ questions extracted from PAQ question bank at step 104. The PAQ test answers are graded and analyzed at 105 and 106. If necessary, more PAQ questions will be given to the student and graded and analyzed until a precise and accurate in-depth analysis is achieved. A knowledge branch (as shown in FIG. 5) will be created at 107 to chart a student's test data in a color-coded elemental map based on correct and incorrect answers. Students can observe their test results in the Knowledge Branch that allows them to actually see their learning gaps. It helps teachers and students to understand more about the student's strength and weaknesses of learning and is critical to supporting and facilitating good instruction and good learning.

The knowledge branch (as shown in FIG. 5) includes at least one child node and one parent node. Each child node is connected to its parent node in a recursive manner and continues until they reach the final element (the most general element at the top of the hierarchy). Knowledge branch allows teachers to pinpoint specific constructs or ideas that will help students gain a better, more conceptual understanding of a subject matter. It also increases knowledge retention.

The PAQ questions are designed according to different groups, when a student's standard test result shows an ambiguous outcome on a particular concept then they can be re-tested on that particular subject/group/concept. The data generated can also be used to create the knowledge branch. Data driven instruction is more important than ever in an era of declining budgets. It is suggested that immediate scoring and detailed diagnostic reports are the most important product features when evaluating assessment programs.

By using knowledge branch and PAQ test, students can actively participate in teaching and the learning process. They can be involved both as assessors of their own learning and as resources to other students. Research shows that the involvement in and ownership of their work increases students' motivation to learn. When teachers know how students are progressing and where they are having trouble, they can use this information to make necessary instructional adjustments, such as re-teaching, trying alternative instructional approaches, or offering more opportunities for practice. These activities can lead to improved student achievements. Teachers are critical in identifying learning goals, setting clear criteria for success, and designing assessment tasks that provide evidence of student learning.

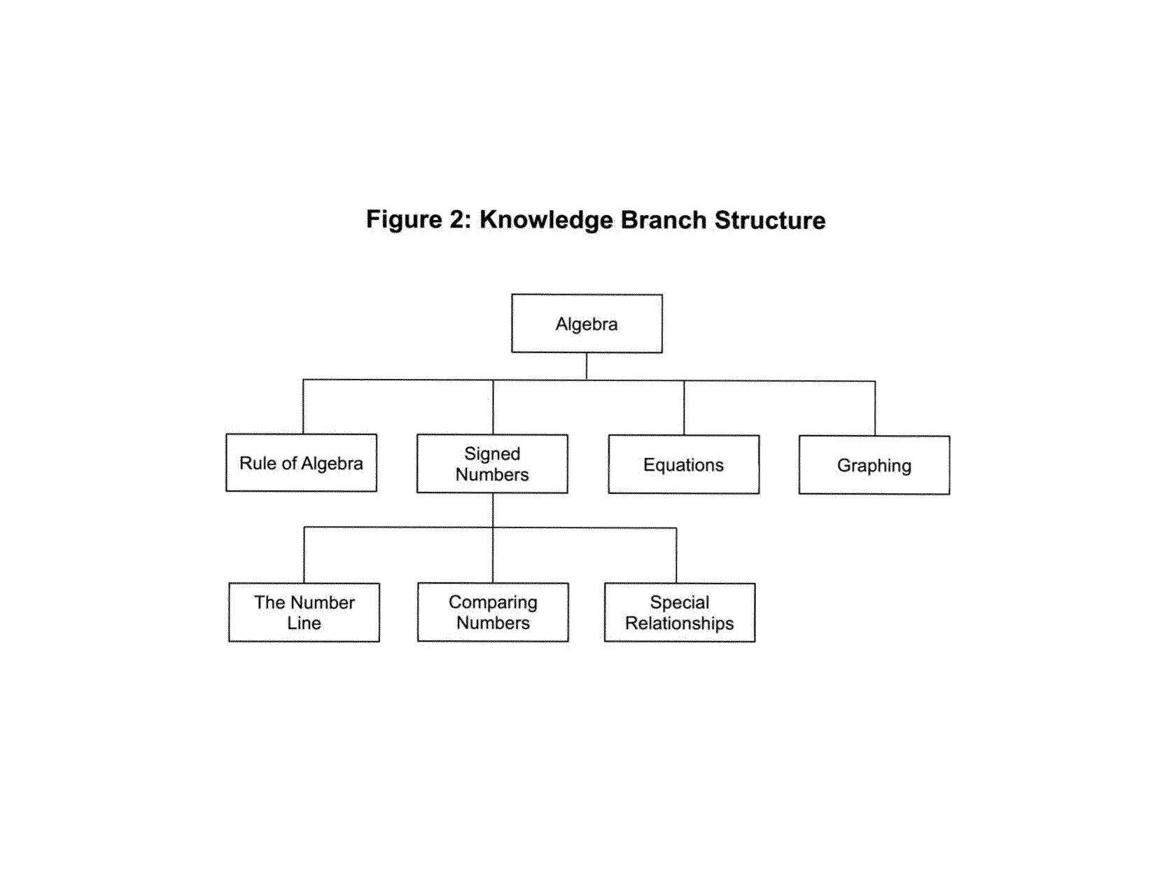

Referring to FIG. 2, there is a disclosed knowledge branch structure. Using the subject Algebra as an example, Algebra can be divided (categorized) in several groups such as Rules of Algebra, Signed Numbers, Equations, and Graphing, etc. Each group can be further divided to several sub-groups. Using Signed Numbers as an example, it can be further divided to The Number Line, Comparing Numbers, Special Relationships, etc.

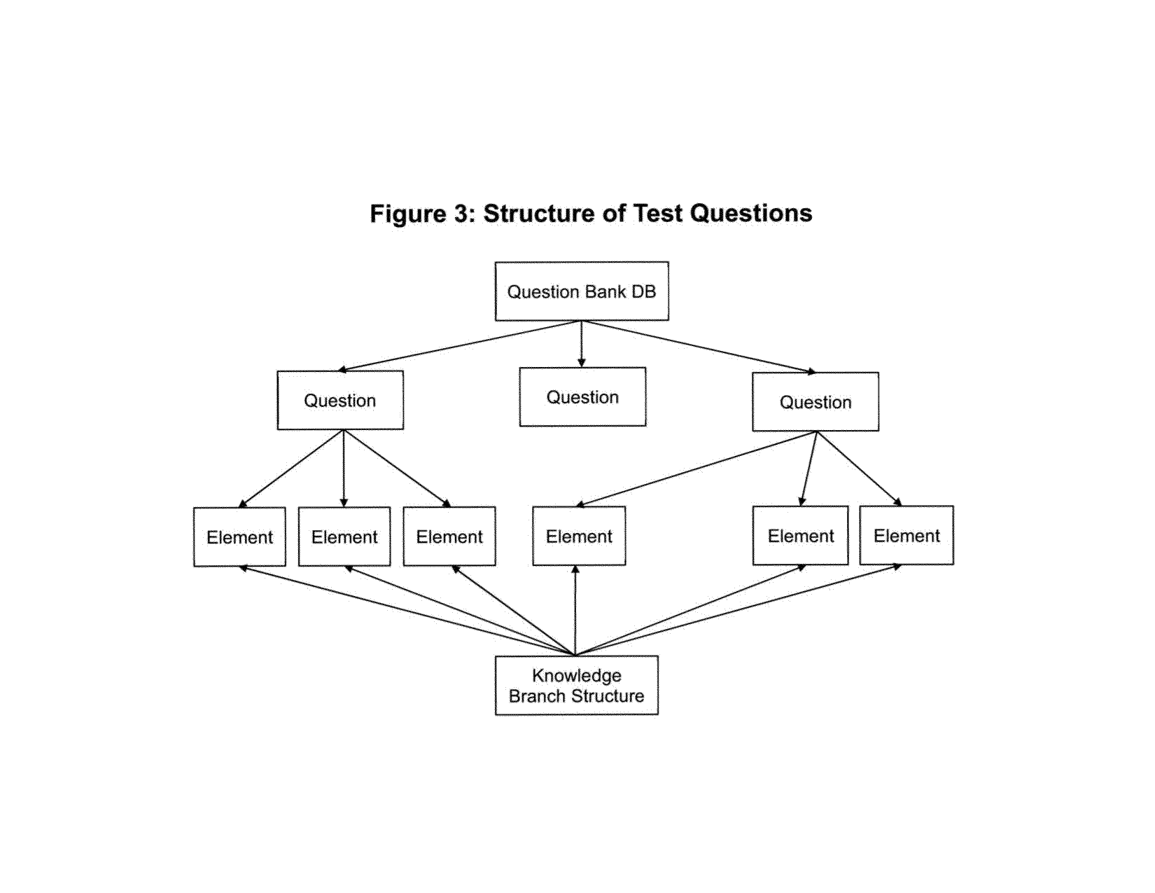

FIG. 3 illustrates the relationship between test questions in Question Bank DB and Knowledge Branch structure. Each question can have multiple elements; those elements become a particular set of elements for a specific question.

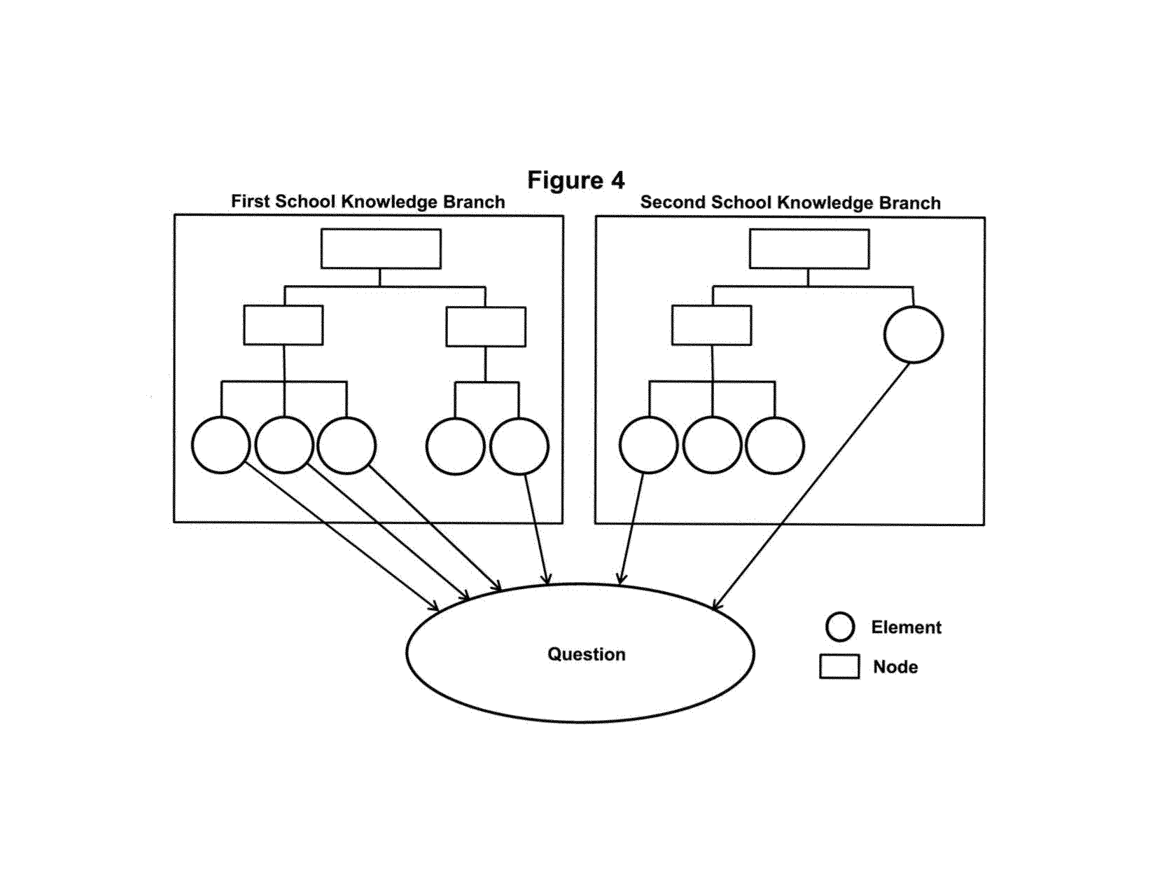

As further illustrated in FIG. 4, for a given question, it can have multiple sets of elements corresponding to a particular taxonomy: school, country, other system, etc. In other words, different schools and even different schools in various countries can have different sets of elements for the same question. Therefore, one test is composed of multiple questions that have many elements. And all of the elements put together according to the various taxonomies can build different knowledge branches.

In this way, teachers and school administrators can not only visualize taxonomies but also compare the varying taxonomies that a single test can generate. They can analyze student performance from these knowledge branches and even investigate the “best”taxonomy based upon the analysis.

The best taxonomy can be identified from the knowledge branch which shows not only students' understanding of concepts but also the order by which they are understood to answer a multiple-element question. For instance, an algebra question can include the following elements: the number line, comparing numbers, order of operation, and special relationships. The order in which these elements are taught in the classroom (essentially a school's curriculum) differs among districts, states and countries.

With the knowledge branch tool, teachers and administrators can observe which taxonomy or put another way, curriculum, allows the student to learn the material more efficiently and accurately. Given the declining performance of students in the U.S., data-driven curricula building and instruction are necessary for schools to increase student performance and prepare them for college coursework.

The element assignment flow 500 shown in FIG. 5 commences at step 501 where a student's answer to a question is examined, if the answer is correct at step 502, the system records that the element on question have been answered correctly at 503. The system further records the time it took the students to answer the lecture questions at 505 and test assessment questions at 506 correctly. If an even count of questions is given at 507, the element score will be recorded and added together to allow for accurate, in-depth analysis of the test data at 508 and 509 to provide a descriptive feedback. If the count of questions is not even, one can return back to step 501 and continue to proceed.

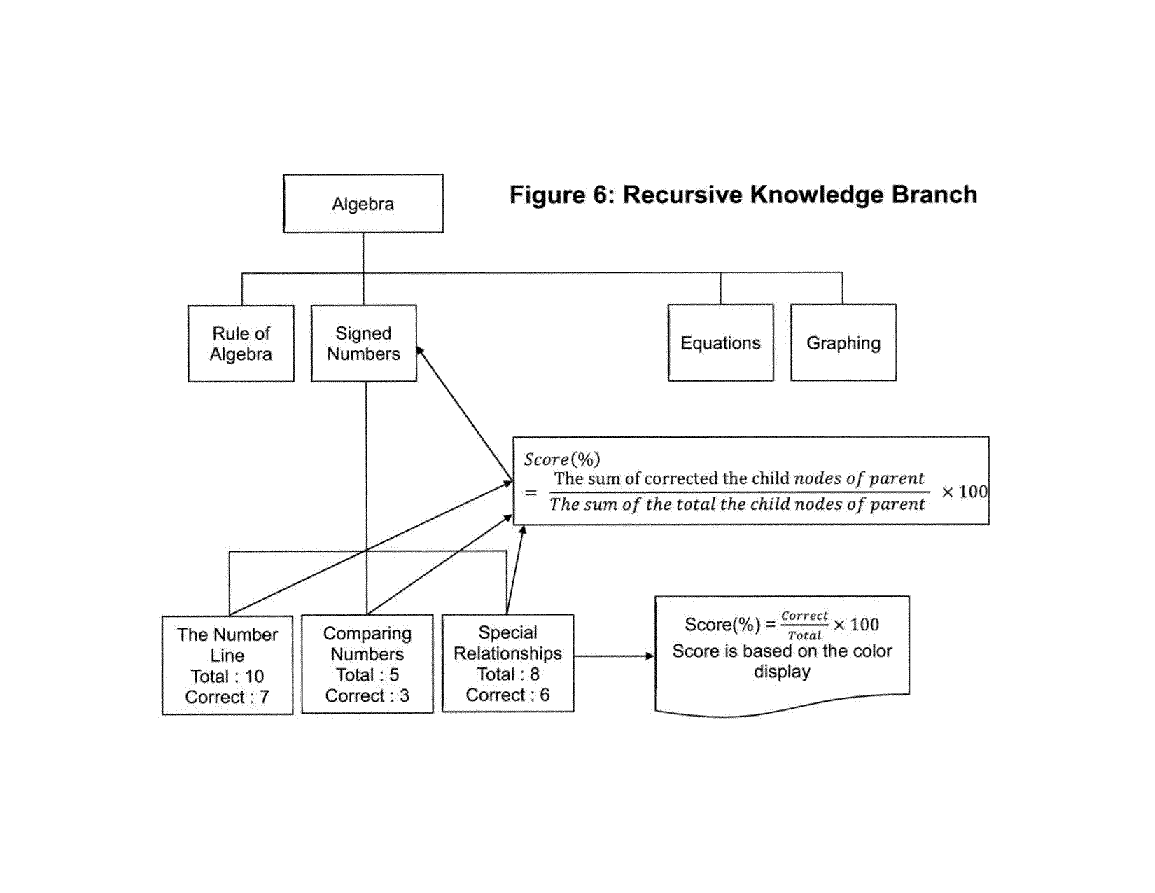

Referring back to FIG. 6, there is disclosed a recursive knowledge branch structure which is a hierarchical in structure. Each child node is connected to its parent node in a recursive manner and continues until they reach the final element (the most general element at the top of the hierarchy). Each knowledge branch structure (element map) includes the following information: name of element, total number of questions, number of correct answers, number of incorrect answers and score (as percentage). Still using Algebra subject as an example, the child node such as the number line, comparing numbers, special relationships are all connected to their parent node “signed numbers” and continue until they reach the final element “Algebra”. The score (percentage) is equal to “the sum of corrected child nodes of parent” divided by “the sum of the total child nodes of parent” and multiplied by 100. If a student gets a high score, it indicates that the student has a comprehensive understanding about the concept of “signed numbers”.

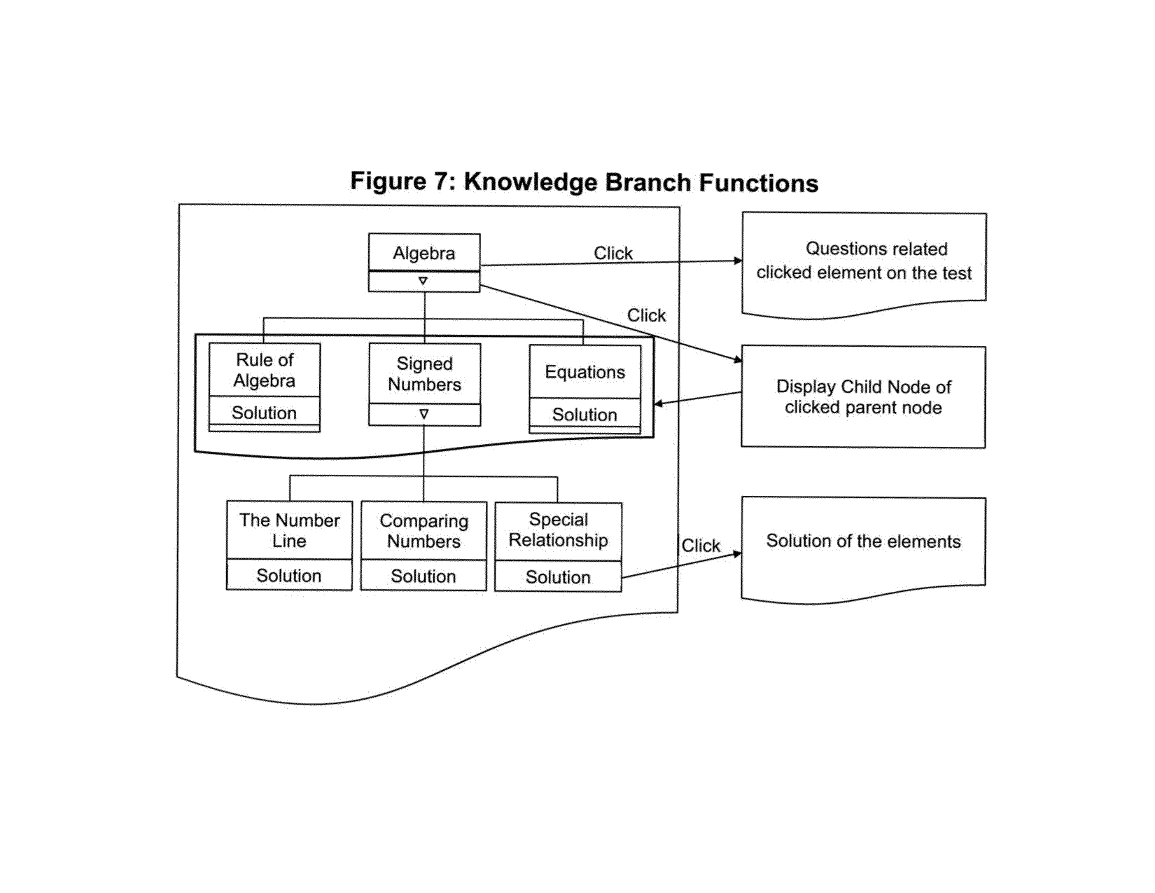

Knowledge Branch structure can be displayed in full or in part, as needed by the viewer. As shown in FIG. 7, each element box has two parts that can each be clicked for the following information. The top portion of the element box can be clicked to view the test questions related to that clicked element. For example, when the top portion of the “Algebra” box is clicked, it will show all questions related to the entire knowledge branch of Algebra. If the top portion of the “signed number” is clicked it will show all questions related to the signed number. If the “comparing numbers” is clicked, it will show all questions related to comparing numbers. While, the bottom portion of the element box can be clicked to display the child node of the clicked parent node. For example, when the bottom portion of the “Algebra” box is clicked, it will show the element boxes of “Rule of Algebra”, “Signed Numbers”, and “Equations”. When the bottom portion of the “Signed number” box is clicked, it will show the element boxes of the “Number Line”, “Comparing Numbers”, and “Special Relationships”. However, when the bottom portion of the element box at the bottom of the hierarchy is clicked, it doesn't lead to a child node (i.e. next level's elements), but instead it leads to the solution of the question.

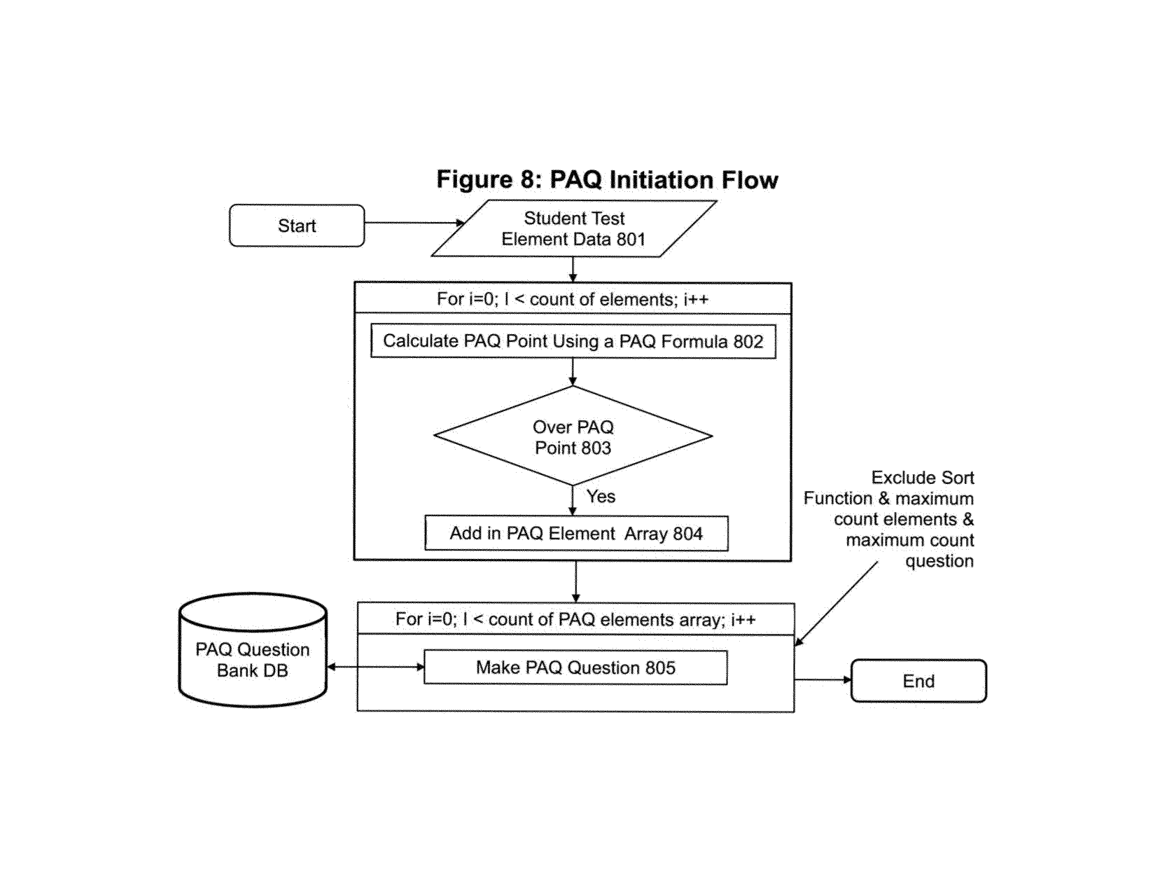

The method of improving teaching assessment and student's achievement according to the present invention can be implemented as an assessment tool on a computer, more specifically through a program/software. An exemplary general pseudo code for the software flow is illustrated in FIG. 8. After a student completes the standardized test, it is graded for a score and analyzed/determined whether a PAQ is needed. If a PAQ is determined necessary for an element that the outcome is ambiguous, questions from the PAQ test bank related to that element will be gathered and formed into a PAQ quiz to give to the student. The results of the PAQ are incorporated into the creation of the knowledge branch structure. The knowledge branch structure can be viewed with or without the PAQ results.

Referring to FIG. 8 there is disclosed a PAQ initiation flow 800. An exemplary general pseudo code for the software flow is illustrated in FIG. 8. In one embodiment, a computer program may be written to have a loop to calculate a student's PAQ point (using a PAQ formula) for each element at step 801 and determine whether the score is over the PAQ point. If yes, then the score is added in PAQ element array 804. Steps 802-804 are repeated until a termination criterion is met. The PAQ Question Bank DB will continue to give the student PAQ questions 805 until the student has all the PAQ elements' score over the PAQ point and the scores have been stored in the PAQ element array. Each content stored in the PAQ element array can be used for descriptive feedback and given to students for them to see where their learning gaps are. Then each test score stored in the PAQ element array will be retrieved through a loop and if the score stored under an index is below the PAQ point, then it means that this particular element needs to be retested. PAQ questions will be pulled from the PAQ Question Bank DB to create a smaller set of questions, which provides more data to further analyze the ambiguous concepts. PAQ initiation flow may be programmed differently in other embodiments.

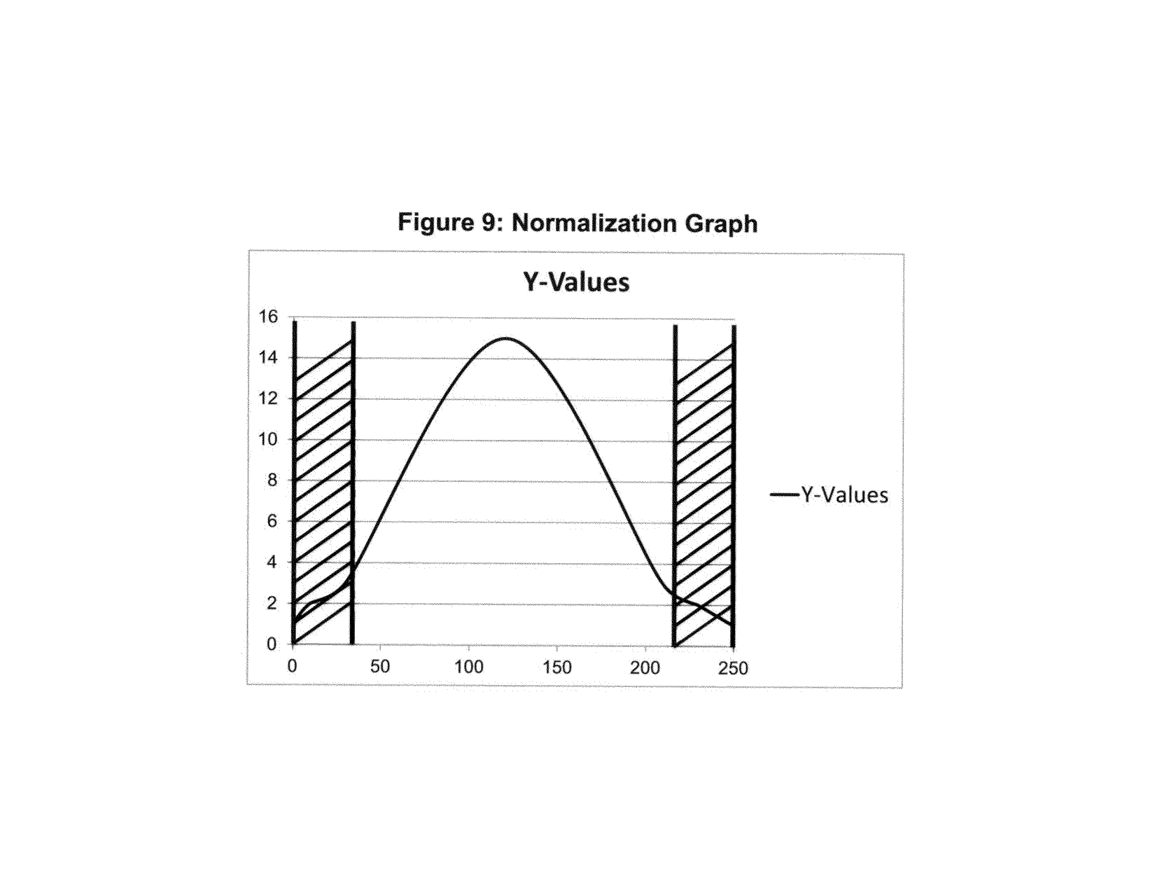

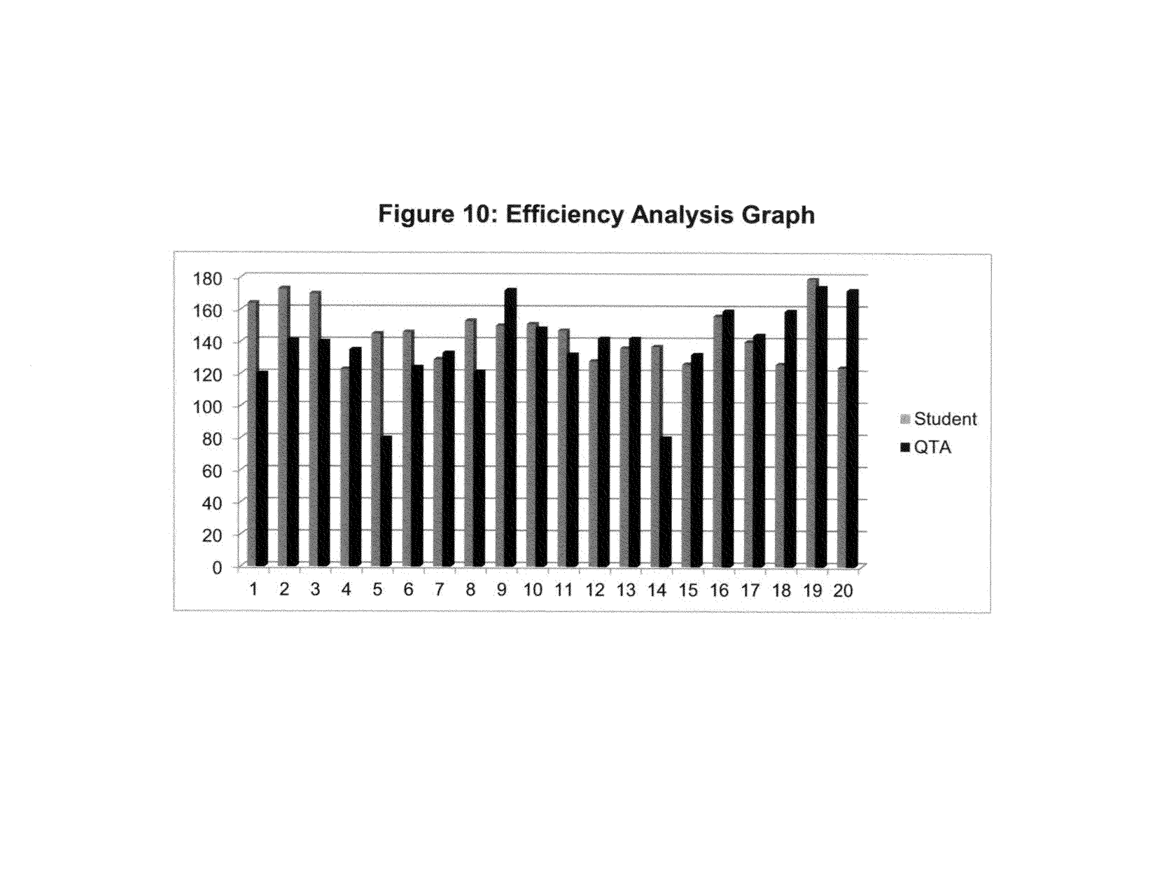

In order to get more in-depth analysis, each question may be timed to measure a student's efficiency in problem-solving. All outliers are eliminated and data is normalized to measure efficiency of only correct answers (as shown in FIG. 9). This data is then used in student-to-student and student-to-overall average comparisons as shown in FIG. 10.

With the results of assessment and standardized tests, teachers analyze which concepts a student has or has not yet mastered as a way to inform future lesson plans. Teachers and schools know that concepts build upon concepts so that curricular development, across all subjects and grade levels, is progressive. Foundational elements are taught before advanced and complex elements and both foundational and complex elements of a subject are tested. In higher grade levels, it becomes extremely difficult to distinguish between the two.

The knowledge branch tool, however, allows a teacher and student to visualize the distinctions and actually see where the lack of comprehension is occurring. With the tool, a teacher's curriculum or instructional plan is categorized and broken down into foundational and complex elements. Then, teachers can observe the elements that students consistently answer correctly or incorrectly. Not only that, teachers can observe the order in which the elements are taught and how this affects student performance. With the data, teachers can change or supplement the curriculum to address the needs of students and possibly analyze a more efficient taxonomy for students' learning and mastering. With student data generating multiple knowledge branches, the more efficient taxonomy becomes more easily identifiable.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A system for improving test assessment and student's achievement comprising:
at least one knowledge branch which charts a student's test data in a color-coded elemental map, the knowledge branch being hierarchical in structure including at least one child node and one parent node, each child node and parent node corresponding to at least one element box.

2. The system of claim 1 wherein the elemental map is hierarchical in structure including a plurality of elements, each element includes the following information: name of element, total number of questions, number of correct answers, number of incorrect answers and score (as percentage).

3. The system of claim 2, wherein each element in the map is color-coded according to correct and incorrect answers.

4. The system of claim 1, wherein each child node is connected to its parent node in a recursive manner and continues until they reach the final element (the most general element at the top of the hierarchy).

5. The system of claim 4, wherein the knowledge branch structure can be displayed in full or in part, as needed by the viewer.

6. The system of claim 5, wherein the element box has two parts that can each be clicked for the following information, the top portion of the element box can be clicked to view the test question related to that element; the bottom portion can be clicked to open the knowledge branch structure to the next level's elements.

7. The system of claim 5, wherein the element box has two parts that can each be clicked for the following information, the top portion of the element box can be clicked to view the test question related to that element; the bottom portion can be clicked to open the solution to the test question.

8. The system of claim 1 further comprises PAQ to enhance the accuracy and depth of test data analysis.

9. The system of claim 8, wherein the results of the PAQ are incorporated into the creation of the knowledge branch structure.

10. The system of claim 9, wherein the knowledge branch structure can be viewed with or without the PAQ results.

11. A method of improving test assessment and student's achievement comprises:
Giving a student a standardized test;
Grading the student's test and calculating the score; and
creating at least one knowledge branch where a student's test data is in a color-coded element map, the knowledge branch has a plurality of element boxes which can be displayed in full or in part as needed by the viewer, the element box has two parts, the top portion of the element box can be clicked to view the test question related to that element.

12. The method of claim 11 further comprises determining whether a PAQ is needed.

13. The method of claim 12 further comprises gathering questions from the PAQ test bank which are related to the element that is ambiguous in student's standardized test result and formed into a quiz that the student takes.

14. The method of claim 13 further comprises measuring a student's efficiency in problem-solving by recording how much time is spent on the question, averaging the time spent on the questions that are answered correctly, normalizing the average time, then using the normalized average time to compare student-to-student and student-to-overall average.

15. The method of claim 14 further comprises providing qualitative feedback for both student and teacher that focuses on the details of content and performance.

16. The method of claim 11, wherein the bottom portion of the element box can be clicked to open the knowledge branch structure to the next level's elements.

17. The method of claim 11, wherein the bottom portion of the element box can be clicked to open solution to the test question.

18. The system of claim 1, wherein multiple knowledge branches can be derived from a given question depending upon the taxonomy of elements determined by different school systems, district/federal standards, country standards, international codes.

19. The system of claim 18, wherein the given question can have multiple elements which become a particular set of elements for said question.

20. The system of claim 19, wherein different schools and even different schools in various countries can have different sets of elements for the same question.
